(19) United States
(12) Patent Application Publication
(10) Pub. No.: US 2024/0428128 A1
(43) Pub. Date: Dec. 26, 2024

(54) COMPUTING SYSTEM FOR IMPLEMENTING SYSTEM MODEL USING BIG DATA MACHINE LEARNING

(71) Applicant: KOREA DIGITAL TWIN LAB. Inc., Daejeon (KR)

(72) Inventors: Tag Gon KIM, Daejeon (KR); Ho Dong YOO, Daejeon (KR); Young Jin YANG, Jeju-si (KR)

(73) Assignee: KOREA DIGITAL TWIN LAB. Inc., Daejeon (KR)

(21) Appl. No.: 18/341,055

(22) Filed: Jun. 26, 2023

(51) Int. Cl. G06N 20/00

(52) U.S. Cl. CPC G06N 20/00

(57) ABSTRACT

Provided is a computing system for implementing a system model using big data machine learning, which is intended to build a hypothetical model, calculate verified parameter values by performing machine learning on big data acquired from an actual system, and apply the verified parameter values to the hypothetical model. A system modeling method of completing a simulation model for a target system by causing a hypothetical model defined by acquiring knowledge about the target system to perform machine learning on big data acquired by running and observing the target system includes defining a hypothetical model for a target system by finding acquirable information related to the target system.

### BACKGROUND

### Field of the Invention

The present invention relates to a computing system for modeling and simulating a physical complex system, and more particularly, to a computing system for implementing a system model using big data machine learning.

### Discussion of Related Art

To analyze or predict an operation or performance of a system in the real world, generally, an abstracted model is created for the system and executed, and measurements in aspects of interest, such as operation/performance, are measured and observed. In order to obtain reliable results of analyzing/predicting the target system through the model, it is important to accurately model the system.

As a modeling method, there is a method of creating an abstract model using knowledge of physical laws, operating rules, or the like included in a target system. This is a modeling and simulation (M&S)-based method which may express the causal relationship between a controlled input and the corresponding output. This method has a limitation that detailed information on a system to be modeled should be available. Also, when a model is built according to the M&S-based method, a model validation process of determining how accurately the model reflects the actual system is required to ensure validity of the model. When it is difficult to acquire data from a real-world system, the validity of a model cannot be determined, and thus it is not possible to ensure the reliability of analysis/prediction results based on the model.

As another modeling method for predicting and analyzing a system, there is a data modeling method in which rules/patterns/functions included in the system are derived by analyzing too much data acquired through running and observation of the target system. A machine learning-based model which may be called a representative data modeling method, is a method of representing the correlation between one set of data and another set of data. In the era of big data, more effective machine learning has become possible using large amounts of data. Here, a data model built through machine learning can make a prediction on the assumption that the corresponding system will operate without any change in the future. However, when the configuration, operating rules, or the like of the system change, it is not possible to make a prediction with the previously trained model.

The term “big data” is becoming well known as a means of predicting a diversified society. Big data refers to a dataset whose size exceeds the ability of common software to collect, manage, and process data in an allowed time period. Since such a large amount of data provides deeper insight than a limited amount of existing data, big data is attracting attention in research in various fields such as science, engineering, national defense, management, medicine, politics, etc. For this reason, modeling using big data is becoming an essential and important issue in the big data era.

Modeling using big data may be defined as data modeling that focuses on representing data correlations. In research, such approaches are classified into two types, data mining and machine learning. FIG. 1 shows methods of performing data modeling in the two ways.

Data mining is a useful data modeling method shown on the left side in FIG. 1. A user who wants to predict a system result using the data mining technology may analyze a pattern or attributes of data in one dimension and also identify a distribution function of data in the data pattern.

After that, the user may verify the distribution function on the basis of real-world data using a fitness test such as a goodness of fitness (GOF) test and then obtain a “random number generation” model. The finally obtained model may be used in a process of predicting a future data pattern.

Meanwhile, machine learning may be another means of data modeling. A user may map one dataset d1 to another dataset dn using a machine learning algorithm such as an artificial neural network (ANN) or a genetic algorithm (GA).

Like in a data mining process, a data model may be acquired through a process of verifying the validity of actual map data using a general performance index such as a root-mean-square error (RMSE). After that, a future value of the dataset dn may be predicted using the given dataset d1.

Such data modeling is performed through a process of acquisition, modeling, verification, and prediction. Data modeling has been widely used in various fields, such as science, engineering, economy, industry, and the like to predict future behavior of a target system, and some researchers argue that correlations are strong enough to make an informative prediction when enough information is given.

However, unlike such an expectation, data modeling is not always a powerful modeling method. This method has some limitations, a representative one of which is that the method may describe a correlation between data rather than representing the causal relationship between a controlled input and a corresponding output.

With a data model, it is not possible to handle a sudden situation and a changing situation of a system. In other words, when a component or a structure/behavior of the system changes after a model is trained, accurate prediction is impossible through the data model.

Another limitation is that it is not possible to handle an unexpected event. In a real system, unexpected events may occur due to the complexity and uncertainty of the system. The events are not included in datasets that we may generally acquire. A data model based on an original dataset may not accurately predict such an unexpected event.

Similarly, there is a limitation that prediction results are influenced by the amount of data acquired from a target system.

To overcome these limitations of data modeling, simulation modeling based on system science is necessary. Simulation modeling may be defined as a theory-based modeling method commonly used in the field of simulation. In simulation modeling, physical or operating rules existing in a target system are used to build a model.

In this way, unlike data modeling, it is possible to clearly represent the causal relationship between a set of control inputs and corresponding outputs. Nevertheless, simulation modeling alone cannot be a perfect solution for modeling complex systems in the big data era.

For example, when it is difficult to obtain sufficient knowledge about a system, it is impossible to build an M&S model completely satisfying a purpose. This is because the simulation modeling approach is based on prior knowledge of a target system and the completion of the M&S model depends on the depth of understanding about the system. Accurate simulation modeling requires extensive physical and operational knowledge of the target system.

After a simulation model is built, a process of checking the validity of the model through model verification is necessary. However, when there is no data for verification in the actual system or it is difficult to obtain data for verification, it is difficult to check the validity of the model.

As described above, the two modeling methods have obvious limitations.

FIG. 2 illustrates these limitations with a simple example. In the case of modeling a system having inputs x1, x2, x3, and x4 and an output y shown at the top of FIG. 2, simulation modeling is used as shown on the right side. A system model may be built on mathematical knowledge about the target system but becomes valid when a value output from the model is validated through data acquired by the actual system.

On the other hand, when machine learning is performed with the data x1, x2, x3, x4, and y obtained by running the system as shown on the left side, it is possible to obtain an accurate model that outputs y from the inputs x1, x2, x3, and x4. However, when system operating rules shown at the top of FIG. 2 are changed, for example, when the system operating rule “×” representing multiplication at the top of FIG. 2 is changed into “÷” representing division, a machine learning model obtained from previously acquired big data cannot properly predict the output y of the research target system in which the system operating rule is changed.

To address the above-described problems of the two modeling methods according to the related art, robust analysis/prediction support is necessary, which requires a mutually cooperative method of overcoming limitations of each approach using the strengths of the two modeling methods in a complementary manner.

### SUMMARY OF THE INVENTION

The present invention is directed to providing a computing system for implementing a system model using big data machine learning in which verified parameter values are calculated by performing machine learning on big data acquired through running and observation of a target system in the real world using a function block provided by a hypothetical model defined by acquiring knowledge about the target system for analyzing or predicting operation/performance, and a system model is built by applying the verified parameter values to the hypothetical model.

According to an aspect of the present invention, there is provided a computing system for implementing a system model using big data machine learning, the computing system including at least one processor and a hypothetical model defined on the basis of structural information which is related to a target system for analyzing or predicting operation/performance in the real world and acquirable by acquiring knowledge about the target system, and including a plurality of function blocks therein.

The plurality of function blocks include one or more first function blocks configured to have first data as an input and second data as an output among big data acquired by actually running and observing the target system on the basis of the structural information and one or more second function blocks configured to have the second data as an input and third data as an output among the big data on the basis of the structural information. At least one of the one or more first function blocks and the one or more second function blocks is a machine learning function block for machine learning.

The at least one processor controls a first machine learning function block included in the one or more first function blocks so that machine learning may be performed by the first machine learning function block using the first data as an input and the second data as an output among the big data or controls a second machine learning function block included in the one or more second function blocks so that machine learning may be performed by the second machine learning function block using the second data as an input and the third data as an output.

The hypothetical model and the plurality of function blocks may be defined on the basis of domain knowledge, experience, and a theory which are acquirable regarding the target system.

When machine learning is performed by the first machine learning function block, the at least one processor may acquire a verified first parameter value and use the first parameter value as information for verifying the first machine learning function block, or when machine learning is performed by the second machine learning function block, the at least one processor may acquire a verified second parameter value and use the second parameter value as information for verifying the second machine learning function block.

When the first parameter value and the second parameter value are applied to the hypothetical model, the at least one processor may complete a system model, analyze and predict operation/performance of the target system through simulation of the completed system model, collect history data related to failures of the target system during an entire lifespan of the target system, transmit the collected history data related to the failures to a condition-based maintenance (CBM) cloud (e.g., an Internet of things (IoT) cloud) which is connected to communicate via a cloud communication network and interoperates with the computing system including the at least one processor, and cause the CBM cloud to predict a remaining useful life (RUL) of the target system based on a current time using the history data related to the failures collected by the CBM cloud.

The first parameter value or the second parameter value may include a variable value, a probability, a function, or a graph which is input to the first machine learning function block or the second machine learning function block.

The first data may be data represented as an input to the hypothetical model on the basis of the structural information, the second data may be data represented as an internal variable of the hypothetical model on the basis of the structural information, and the third data may be data represented as an output of the hypothetical model on the basis of the structural information.

The at least one processor may receive new input data for the target system, input the new input data to the hypothetical model, control the hypothetical model so that an inference process of the hypothetical model is performed, and provide an output of the hypothetical model as a result of the hypothetical model inferring an output of the target system from the new input.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a process of performing data modeling in the two ways of data mining and machine learning according to the related art;

FIG. 2 is a diagram illustrating limitations of the two modeling methods of FIG. 1 according to the related art;

FIG. 3 is a block diagram of a computing system for implementing a system model using big data machine learning according to the present invention;

FIG. 4 is a flowchart illustrating an operating process of a computing system for implementing a system model using big data machine learning according to the present invention;

FIG. 5 is a diagram illustrating a specific embodiment of FIG. 3;

FIG. 6 is a diagram illustrating a target system simulation operation of a system model which is completed by applying parameter values of FIG. 5 to a hypothetical model according to an embodiment of the present invention;

FIG. 7 is a diagram illustrating a simulation operation for analyzing and predicting the target system shown in FIG. 6 according to another embodiment of the present invention;

FIG. 8 is a diagram illustrating an operation of simulating a target system by performing mutual communication through a machine-to-machine (M2M) or Internet of things (IoT) platform according to an embodiment of the present invention;

FIG. 9 is a diagram illustrating the definition of cellular automata applied to a hypothetical model in FIG. 5 and a state update method according to an embodiment of the present invention; and

FIG. 10 is a diagram illustrating a state transition function of each cell in the cellular automata of FIG. 9 according to an embodiment of the present invention.

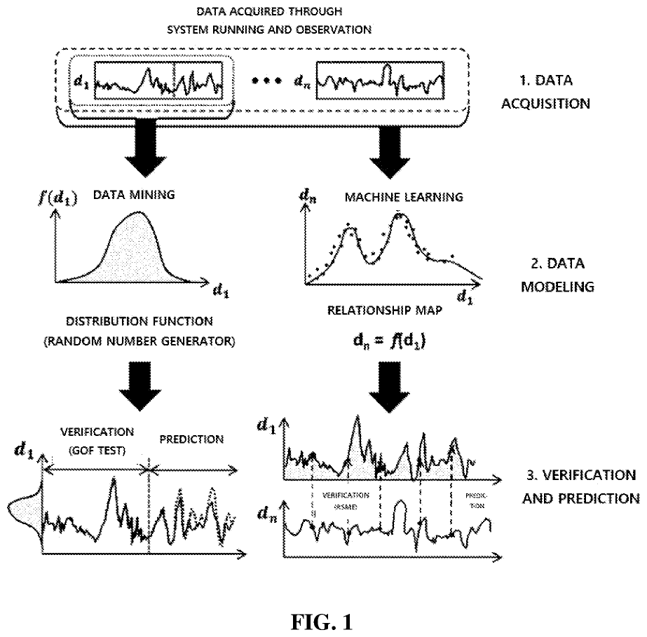

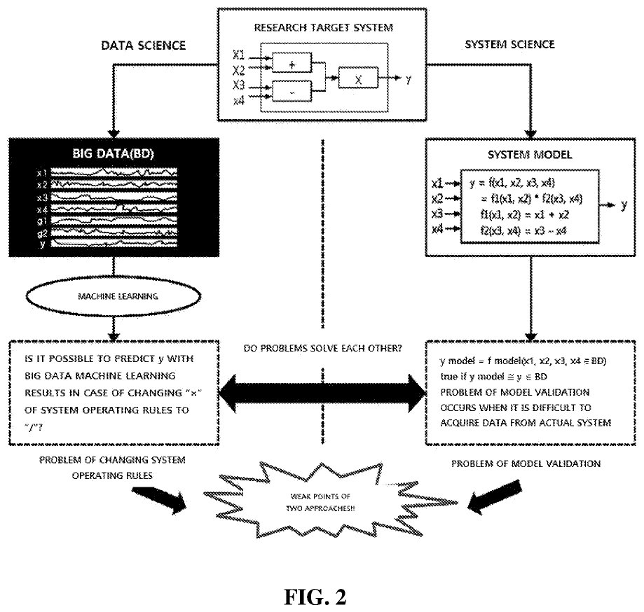

### DETAILED DESCRIPTION OF EXEMPLARY EMBODIMENTS

Hereinafter, exemplary embodiments of the present invention will be described in detail with reference to the accompanying drawings.

A computing system for implementing a system model using big data machine learning described below according to the present invention is not limited to the following exemplary embodiments and may be modified by those of ordinary skill in the art without departing from the technical spirit stated in the claims.

Terminology used herein is for the purpose of describing specific embodiments rather than limiting the present invention.

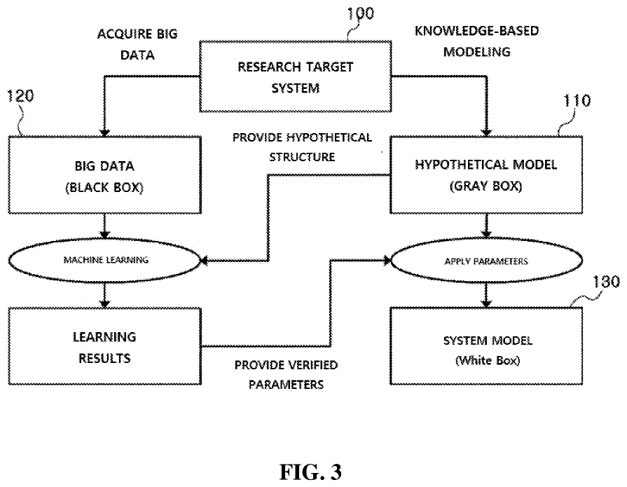

A configuration and detailed process according to the exemplary embodiments of the present invention will be described in detail below with reference to FIGS. 3 to 10.

First, the present invention relates to a computing system for implementing a cooperative modeling method by applying a machine learning method to modeling and simulation-based modeling, which predicts operational/functional functions, parameters, etc. required for specifying a hypothetical model using a machine learning method with big data actually acquired from a target system for analyzing or predicting operations/performance in the real world.

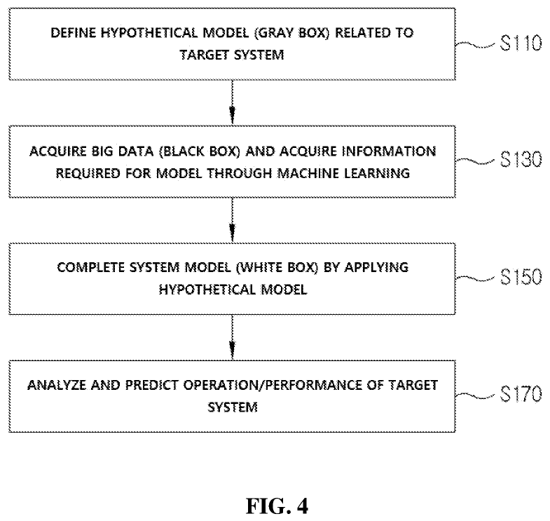

FIGS. 3 and 4 are a block diagram of a system in which big data machine learning is embedded and a flowchart of a modeling process according to an exemplary embodiment of the present invention. Referring to FIGS. 3 and 4, it is necessary to analyze requirements of a user according to a purpose of modeling and simulation of a target system 100 to be modeled.

Since modeling is a process of abstracting the target system 100 according to a preset purpose rather than completely expressing the entire target system 100, system modeling fit for the purpose is important.

For system modeling, first, a hypothetical (gray box) model 110 for the system is defined by finding obtainable domain knowledge/experiment, theories, and the like related to the target system 100 (S110).

Since simulation is not enabled by the hypothetical model 110 itself, it is necessary to build a complete model by acquiring information, such as an operation function, parameters, and the like required to complete a model.

Big data 120 is acquired by running/observing the system 100 to be modeled, and machine learning is performed on the acquired big data 120 to acquire information required to complete the hypothetical model 110 (S130).

In other words, information required for the hypothetical model 110 may be learned using a machine learning algorithm, such as an artificial neural network (ANN) or the like, on the big data 120 acquired by running and observing the actual system 100.

A system model (white box model) 130 for the target system 100 is completed by applying information learned and verified on the basis of the actual data to the hypothetical model 110 (S150).

Finally, operation/performance of the target system 100 in the real world is analyzed and predicted through simulation of the completed system model 130 (S170).

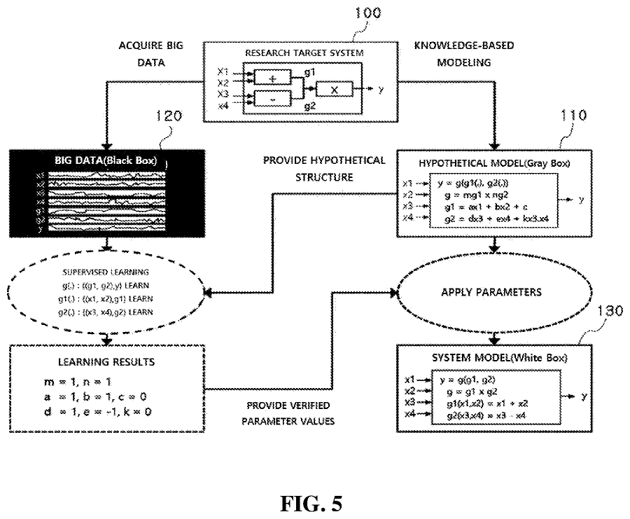

FIG. 5 is a diagram illustrating a specific embodiment of FIG. 3. First, knowledge-based modeling is performed to define the hypothetical model 110 of the target system 100 by acquiring knowledge about the target system 100. A structural feature of the target system 100 may be obtained as the hypothetical model 110, but the coefficients “m, n, a, b, c, d, e, and k,” that is, actual values, are unknown.

Therefore, multiple function blocks in the hypothetical model 110 calculate verified parameter values by performing machine learning on big data according to each function block, and the calculated parameter values are provided to the hypothetical model 110 as necessary information.

More specifically, the coefficients may be learned from the big data 120 (x1, x2, x3, x4,g1, g2, and y) acquired by actually running and observing the target system 100, and each function block performs machine learning through a learning method such as an ANN.

In other words, g(.), g1(.), and g2(.) may be learned using “g1, g2, y,” “x1, x2, g1,” and “x3, x4, g2,” respectively.

Here, the parameter values include variable values, probabilities, or graphs as well as functions, which are contained in each function block.

In this way, verified values of the parameters m, n, a, b, c, d, e, and k are calculated through learning. When the parameter values are applied to the hypothetical model 110, the system model 130 is completed, and operation/performance of the target system 100 is analyzed and predicted through simulation of the completed system model 130.

In the computing system for implementing a system model using big data machine learning described below according to the present invention, when machine learning is performed by the first machine learning function block, at least one processor which controls machine learning function blocks included in function blocks of the hypothetical model 110 acquires a verified first parameter value and uses the first parameter value as information for verifying the first machine learning function block, or when machine learning is performed by a second machine learning function block, the at least one processor acquires a verified second parameter value and uses the second parameter value as information for verifying the second machine learning function block.

When the first parameter value and the second parameter value are applied to the hypothetical model 110, the at least one processor completes the system model 130 and analyzes and predicts operation/performance of the target system 100 through simulation of the completed system model 130.

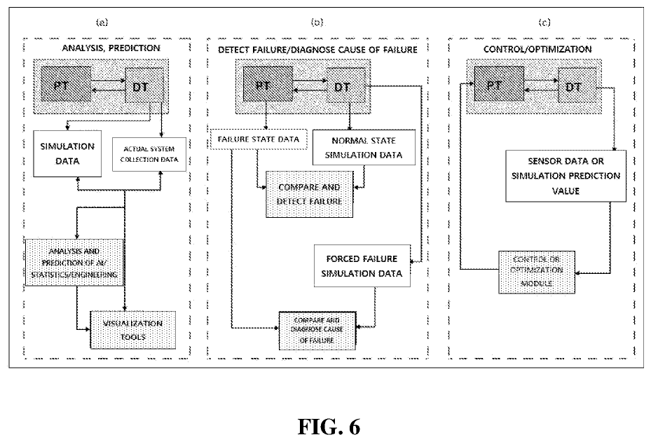

FIG. 6 is a diagram illustrating a target system simulation operation of the system model 130 which is completed by applying parameter values of FIG. 5 to the hypothetical model 110.

FIG. 6A illustrates a simulation operation for analyzing and predicting a research target system 100.

As shown in FIG. 6A, simulation data for analyzing and predicting the research target system 100 is collected through simulation of the completed system model 130. The collected simulation data and actual system collection data of the research target system 100 are used in analysis and prediction of artificial intelligence (AI), statistics, and engineering, and visualization tools required for analysis and prediction of AI, statistics, and engineering are provided.

FIG. 6B illustrates a simulation operation for detecting a failure of the research target system 100 and diagnosing a cause of the failure.

As shown in FIG. 6B, failure state data of the research target system 100 is collected through simulation of the completed system model 130. The collected failure state data is compared with normal state simulation data of the research target system 100 and used for detecting a failure of the research target system 100 or compared with forced failure simulation data and used for detecting a failure of the research target system 100.

FIG. 6C illustrates a simulation operation for controlling or optimizing the research target system 100.

As shown in FIG. 6C, a control or optimization module is provided that collects sensor data or simulation prediction values of the research target system 100 through simulation of the completed system model 130 and controls or optimizes the research target system 100 using the sensor data or simulation prediction values.

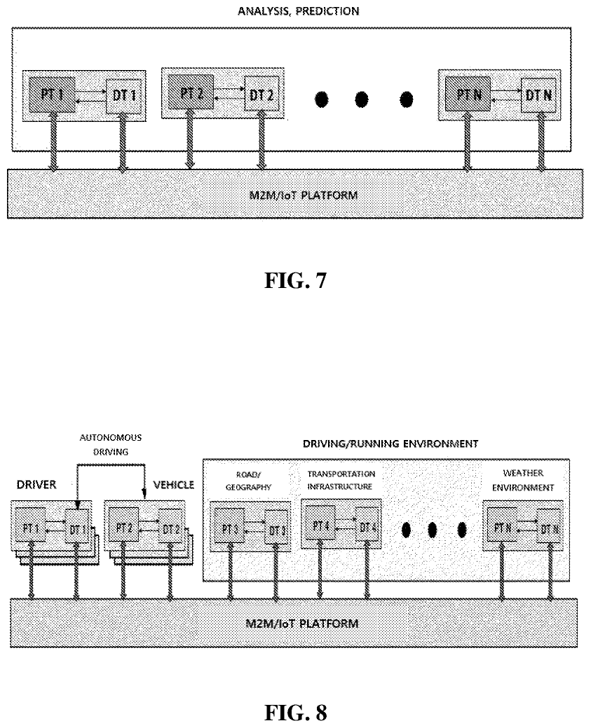

FIG. 7 is a diagram illustrating a simulation operation for analyzing and predicting the research target system 100 shown in FIG. 6A according to another embodiment of the present invention.

In FIG. 7, at least two processors that complete the system model 130 perform a simulation operation for analyzing and predicting the research target system 100 in communication with each other through machine-to-machine (M2M) or the Internet of things (IoT). In particular, the at least two processors collect simulation data for analyzing and predicting the research target system 100 through simulation of the system model 130 which is completed when the at least two processors communicate with each other through an M2M or IoT platform and exchange information or share situational awareness, use the collected simulation data and actual system collection data of the research target system 100 for analysis and prediction of AI, statistics, and engineering, and provide visualization tools required for analysis and prediction of AI, statistics, and engineering.

Although not shown in the drawings, the simulation operation for detecting a failure of the research target system 100 and diagnosing a cause of the failure shown in FIG. 6B and the simulation operation for controlling or optimizing the research target system 100 shown in FIG. 6C may be performed when the at least two processors which complete the system model 130 communicate with each other through M2M or the IoT.

FIG. 8 is a diagram illustrating an operation of simulating the research target system 100 by performing mutual communication through the M2M or IoT platform according to an embodiment of the present invention.

In FIG. 8, the at least two processors which complete the system model 130 perform a simulation operation of the research target system 100 in communication with each other. In particular, the at least two processors create a service in which the research target system 100 is combined with M2M or the IoT through simulation of the system model 130 completed when the at least two processors communicate with each other through the M2M or IoT platform and exchange information or share situational awareness.

For reference, in the exemplary embodiment shown in FIG. 8, at least two processors create an autonomous driver service, an autonomous vehicle service, a road/geography service related to a driving/running environment, a transportation infrastructure service, a weather environment service, or the like in which the research target system 100 is combined with M2M or the IoT through simulation of the system model 130 completed when the at least two processors communicate with each other through the M2M or IoT platform and exchange information or share situational awareness.

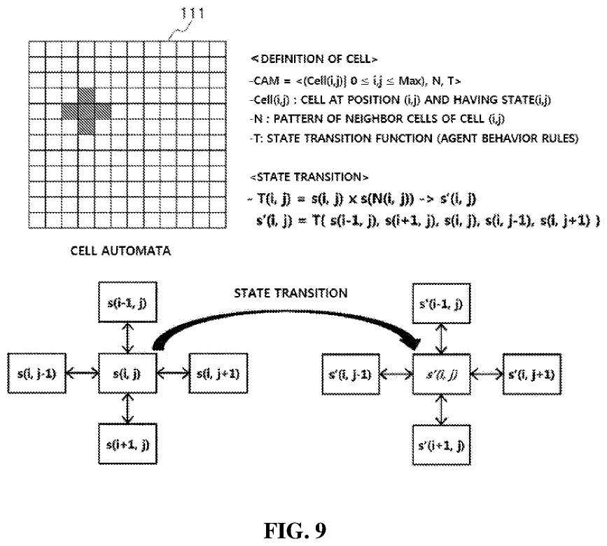

FIG. 9 is a diagram illustrating the definition of cellular automata applied to the hypothetical model 110 in FIG. 5 and a state update method according to an embodiment of the present invention.

As shown in FIG. 9, the hypothetical model 110 is created through a cellular automata model 111, and a transition function of a cell required for a hypothetical model is learned through machine learning on big data 120 and is provided to the cellular automata model 111.

More specifically, a state transition function of a cell required for the hypothetical model 110 is learned through machine learning, such as ANN modeling or the like, with the big data 120 collected from the target system 100 and is provided to the cellular automata model 111 which is a hypothetical model.

In other words, when learned state transition functions are combined with the cellular automata model 111, the system model (white box) 130 is completed. This cooperative approach enables improved modeling in which the problem of verifying a simulation model can be solved through machine learning on big data and the problem associated with a change in system structure and rules can be solved through a hypothetical model based on simulation modeling.

Here, the cellular automata model 111 is a discrete model handled in modeling of mathematics, physics, complex systems, biology, fine structures, etc. and is defined in cells arranged in a regular grid.

Each cell may have a finite number of states, and the grid is defined in a finite number of dimensions. Cells called neighbors of each cell are defined by relationships with the cell. For example, neighbors may be defined as cells next to one cell in all directions.

A state of each cell when a time t is zero (t=0) is designated and called an initial state. A new generation is created from a previous generation by a state transition function, which is a mathematical function for designating a new state of the cell, that is, determining behavior rules of cells, according to states of the cell and the neighbors.

In general, the behavior rules are the same for the cells, do not change over time, and simultaneously apply to all cells of each generation.

The cellular automata and state transition functions are described in detail with reference to FIG. 9. Cell(i, j) is a cell at a position (i, j) and has a state s(i, j). N denotes a neighbor cell pattern, and T denotes a state transition function, that is, behavior rules of an agent. A state of each cell may be defined according to a type of problem such as transportation, water pollution, the spread of fire, etc.

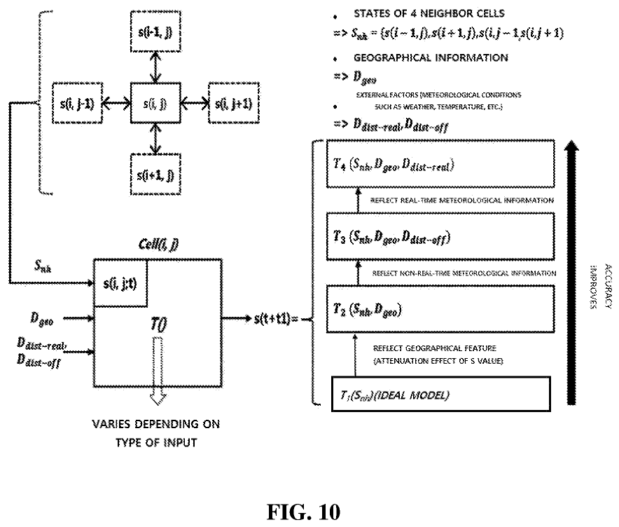

FIG. 10 is a diagram illustrating a state transition function of each cell in the cellular automata of FIG. 9 according to an embodiment of the present invention. It shows how the state transition function differs from a general model.

According to an ideal state transition function, a state transition generally occurs to reflect states of neighbor cells. However, according to the present invention, a state transition occurs when not only states of neighbor cells but also geographical information and external factors (meteorological conditions, such as weather, temperature, etc., and the like) are input.

In other words, an ideal model reflects real-time meteorological information as well as geographical features, and thus an accurate prediction is made for a next cell.

Unlike a method according to the related art, the state transition function is not the same for cells or over time, but varies according to a change in the position of a cell and a change in time. Also, state transition rules are not conclusive and have uncertainty. When a state transition function is obtained using domain knowledge according to the related art, validation is required. On the other hand, when a state transition function is obtained through machine learning on big data, the state transition function is based on actual data, and thus the problem of validation can be solved.

A computing system for implementing a system model using big data machine learning according to the present invention includes the content of machine learning on actual big data therein which is acquired by running and observing a target system, and thus the model becomes a verified model. Also, it is possible to overcome limitations that may be encountered when analyzing or predicting a system of interest using each method. In other words, when machine learning is embedded in a system model, it is possible to lower the level of prior knowledge required for a target system and achieve the effect of model validation. Also, it is possible to analyze and predict system behavior according to a change in a system structure/rule which is not enabled by machine learning alone.

The present invention can be easily applied to any system based on a landscape grid of a forest fire, traffic, a disease, etc.

According to the present invention, a state transition function of a cellular automata model is learned through machine learning on big data. Accordingly, the present invention has the following advantages.

A first advantage is a space-variant feature. A state transition function does not represent all cells and may vary depending on each individual cell. For example, each cell may reflect a geographical feature varying depending on a location.

A second advantage is a time-variant feature. A state transition function may reflect a feature which may vary depending on the time of day such as morning, afternoon, etc.

A third advantage is a stochastic feature. In a traffic simulation, for example, a driver's action may be represented stochastically rather than conclusively. Accordingly, it is important to reflect a stochastic feature through machine learning on big data.

The present invention can reflect nonlinear features of a system. In other words, many systems in the real world have a nonlinear feature that the theorem of superposition does not hold between an input and an output, and thus it is a great advantage that a nonlinear feature can be taken into consideration in a state transition function. Finally, additional information, such as a meteorological condition, can be represented through big data obtained from an actual system.

What is claimed is:

1. A computing system for implementing a system model using big data machine learning, the computing system comprising:
a hypothetical model defined on the basis of structural information which is related to a target system for analyzing or predicting operation/performance in the real world and acquirable by acquiring knowledge about the target system, and including a plurality of function blocks therein; and
one or more processors,
wherein the plurality of function blocks comprise:
one or more first function blocks configured to have first data as an input and second data as an output among big data acquired by actually running and observing the target system on the basis of the structural information; and
one or more second function blocks configured to have the second data as an input and third data as an output among the big data on the basis of the structural information,
wherein at least one of the one or more first function blocks and the one or more second function blocks is a machine learning function block for machine learning, and
the one or more processors control a first machine learning function block included in the one or more first function blocks so that machine learning is performed by the first machine learning function block using the first data as an input and the second data as an output among the big data or control a second machine learning function block included in the one or more second function blocks so that machine learning is performed by the second machine learning function block using the second data as an input and the third data as an output.

2. The computing system of claim 1, wherein the hypothetical model and the plurality of function blocks are defined on the basis of domain knowledge, experience, and a theory which are acquirable regarding the target system.

3. The computing system of claim 1, wherein, when machine learning is performed by the first machine learning function block, the one or more processors acquire a verified first parameter value and use the first parameter value as information for verifying the first machine learning function block, or when machine learning is performed by the second machine learning function block, the one or more processors acquire a verified second parameter value and use the second parameter value as information for verifying the second machine learning function block.

4. The computing system of claim 3, wherein, when the first parameter value and the second parameter value are applied to the hypothetical model, the one or more processors complete a system model and provide a control or optimization module,
wherein the control or optimization module collects simulation data for analyzing and predicting the target system through simulation of the completed system model, uses the collected simulation data and actual system collection data of the target system in analysis and prediction of artificial intelligence (AI), statistics, and engineering, and provides visualization tools required for analysis and prediction of AI, statistics, and engineering,
collects failure state data of the target system through simulation of the completed system model and uses the collected failure state data to detect a failure of the target system by comparing the collected failure state data with normal state simulation data of the target system or uses the collected failure state data to diagnose a cause of the failure of the target system by comparing the failure state data with forced failure simulation data, or
collects sensor data or simulation prediction values of the target system through simulation of the completed system model and controls or optimizes the target system using the sensor data or the simulation prediction values.

5. The computing system of claim 4, wherein at least two of the processors exchange information or share situational awareness in communication with each other through a machine-to-machine (M2M) or Internet of things (IoT) platform, analyze and predict target systems each corresponding thereto through simulation of the completed system model, detect a failure of the target systems corresponding thereto and diagnose a cause of the failure, or provide a control or optimization module for the target systems each corresponding thereto.

6. The computing system of claim 3, wherein, when the first parameter value and the second parameter value are applied to the hypothetical model, the one or more processors complete a system model, and
at least two of the processors create a service in which the target system is combined with machine-to-machine (M2M) or Internet of things (IoT) through simulation of the system model completed when the at least two processors communicate with each other through the M2M or IoT platform and exchange information or share situational awareness.

7. The computing system of claim 3, wherein the first parameter value or the second parameter value includes a variable value, a probability, a function, or a graph which is input to the first machine learning function block or the second machine learning function block.

8. The computing system of claim 1, wherein the first data is data represented as an input to the hypothetical model on the basis of the structural information,
the second data is data represented as an internal variable of the hypothetical model on the basis of the structural information, and
the third data is data represented as an output of the hypothetical model on the basis of the structural information.

9. A computing system for implementing a system model using big data machine learning, the computing system comprising:
a hypothetical model defined on the basis of structural information which is related to a target system for analyzing or predicting operation/performance in the real world and acquirable by acquiring knowledge about the target system, and including a plurality of function blocks therein; and
one or more processors,
wherein the plurality of function blocks comprise:
one or more first function blocks configured to have first data as an input and second data as an output among big data acquired by actually running and observing the target system on the basis of the structural information; and
one or more second function blocks configured to have the second data as an input and third data as an output among the big data on the basis of the structural information,
wherein at least one of the one or more first function blocks and the one or more second function blocks is a machine learning function block for machine learning, and
the one or more processors receive new input data for the target system, input the new input data to the hypothetical model, control the hypothetical model so that an inference process of the hypothetical model is performed, and provide an output of the hypothetical model as a result of the hypothetical model inferring an output of the target system from the new input.
